(19) United States
(12) Patent Application Publication
(10) Pub. No.: US 2006/0044330 A1
(43) Pub. Date: Mar. 2, 2006

(54) Method and apparatus for forming a conveyor belt with an inked image

(76) Inventor: David Fournier, Toms River, NJ (US)

Correspondence Address: PATTERSON & SHERIDAN L.L.P., 595 SHREWSBURY AVE, STE 100, FIRST FLOOR, SHREWSBURY, NJ, 07702, US

(21) Appl. No.: 10/930,572

(22) Filed: Aug. 30, 2004

(51) Int. Cl. B41J 3/00

(52) U.S. Cl. 347/4

(57) ABSTRACT

In one embodiment, a method for forming a conveyor belt having an inked image includes providing at least one belt segment and applying one or more inks to said at least one belt segment to form an embedded image in a surface layer thereof. The resultant image is chemically bonded below a surface of the belt segment and is substantially resistant to fading, cracking and scratching.

### FIELD OF THE INVENTION

The present invention relates generally to conveyor belts, e.g., as used in retail checkout lines, and relates more particularly to conveyor belts having inked images formed therein.

### BACKGROUND OF THE INVENTION

Conveyor belts such as those used in retail checkout lines (e.g., in grocery stores) can provide a substantial amount of revenue when used as advertising space. Advertisements, for example for products and services, may be placed on the outward facing sides of portions of the conveyor belt, so that they are viewable by customers who are waiting in line. As the conveyor belt moves, advertisements for different products and services are displayed.

Several techniques for forming images on conveyor belts are known. These techniques typically involve printing images and/or advertisements “on top” of a PVC belting member, e.g., using digital ink jet printing processes. For example, in some known processes, images are inked onto a base layer or coat on the belting member. A clear coating may then be applied over the inked image before the belting member is cured.

Several problems are inherent in these known processes. For example, because the ink is applied to the surface of the belting member, it is subject to wear, fading and scratching (e.g., from products placed thereon). Moreover, the layering of different materials (having different chemical properties and different inherent flexibilities) can cause the coatings and ink to crack or split. Finally, the time and expense involved in applying the additional material layers (e.g., base and clear coats) on the belting member and curing the belting member can be substantial.

Thus, there is a need in the art for a method and apparatus for forming a conveyor belt with an inked image.

### SUMMARY OF THE INVENTION

In one embodiment, a method for forming a conveyor belt having an inked image includes providing at least one belt segment and applying one or more inks to said at least one belt segment to form an embedded image in a surface layer thereof. The resultant image is chemically bonded below a surface of the belt segment and is substantially resistant to fading, cracking and scratching.

### BRIEF DESCRIPTION OF THE DRAWINGS

So that the manner in which the above recited embodiments of the invention are attained and can be understood in detail, a more particular description of the invention, briefly summarized above, may be had by reference to the embodiments thereof which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is an isometric view of one embodiment of a conveyor belt system in which the present invention may be implemented;

FIG. 2 is a plan view of one embodiment of a conveyor belt segment for use in the conveyor belt system illustrated in FIG. 1;

FIG. 3 is a flow diagram illustrating one embodiment of a method for forming a conveyor belt segment with an inked image;

FIG. 4 is a flow diagram of one embodiment of a method for forming a conveyor belt, such as the conveyor belt illustrated in FIG. 1, using a plurality of conveyor belt segments;

FIG. 5 is a side cross-segmental view illustrating one embodiment of a base belt segment;

FIG. 6 is an isometric view illustrating one embodiment of first and second conveyor belt segments and that are joined together in accordance with the method illustrated in FIG. 4 to form a single conveyor belt; and

FIG. 7 a high level block diagram of the present dynamic resource allocation system that is implemented using a general purpose computing device.

To facilitate understanding, identical reference numerals have been used, where possible, to designate identical elements that are common to the figures.

### DETAILED DESCRIPTION

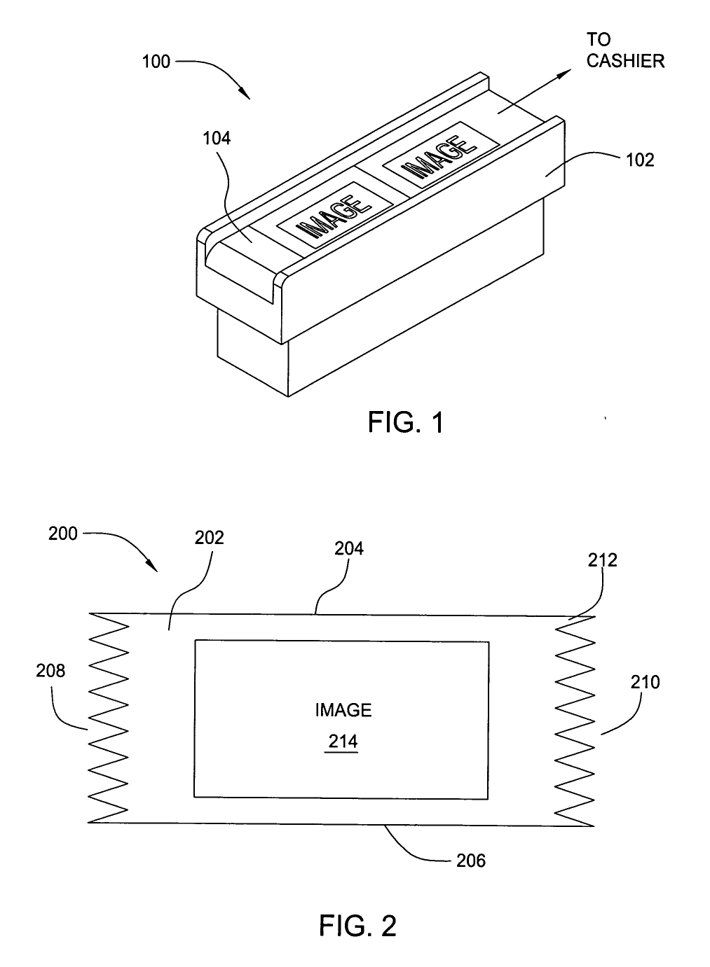

FIG. 1 is an isometric view of one embodiment of a conveyor belt system 100 in which the present invention may be implemented. The system 100 may be used, for example, in retail checkout lines. As illustrated, the system 100 comprises a stationary body or frame 102 on which a conveyor belt 104 rotates in a closed loop (not shown). Customers place objects for purchase on the conveyor belt 104, which transports the products to a cashier for scanning.

FIG. 2 is a plan view of one embodiment of a conveyor belt segment 200, e.g., for use in the conveyor belt 104 illustrated in FIG. 1. In one embodiment, the conveyor belt 104 comprises one or more such segments 200. In one embodiment, conveyor belt segment 200 has first and second substantially parallel longitudinal edges 204 and 206. Third and fourth edges 208 and 210, which are substantially perpendicular to the first and second longitudinal edges 204 and 206, are adapted for coupling to similar edges of other conveyor belt segments (or, in the vase where the conveyor belt 104 comprises a single, long segment 200, to each other). In one embodiment, the third and fourth edges 208 and 210 each comprise a plurality of “teeth” or “fingers” 212 that are adapted to facilitate coupling to other conveyor belt segments as described in further detail below.

The first, second, third and fourth edges 204, 206, 208 and 210 bound a first face 202 of the conveyor belt segment 200. When the conveyor belt segment 200 is deployed in a conveyor belt system such as a retail checkout line, the first face 202 is positioned to be viewed by customers as the conveyor belt passes through the stationary frame 102. The first face 202 comprises one or more inked images 214 formed therein, as described in further detail below. In one embodiment, the images 214 are advertisements for products or services.

In one embodiment, the conveyor belt segment 200 is formed of a substantially flexible material. In one embodiment, the conveyor belt segment 200 is formed of at least one of polyurethane, poly(vinyl) chloride (PVC) or Nitrile rubber.

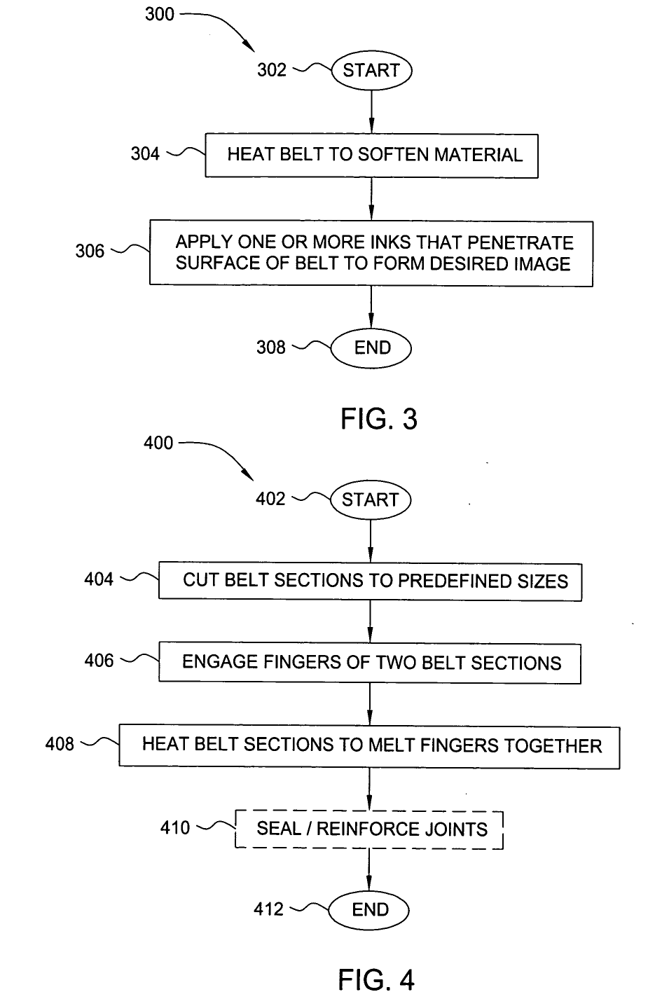

FIG. 3 is a flow diagram illustrating one embodiment of a method 300 for forming a conveyor belt segment (e.g., conveyor belt segment 200) with an inked image. In one embodiment, the method 300 is executed using a modified ink jet printer. The method 300 is initiated in step 302 and proceeds to step 304, where the method 300 heats a base belt segment in order to soften the material. In one embodiment, e.g., where the base belt segment is formed of polyurethane, PVC or Nitrile rubber, the method 300 heats the base belt segment to a temperature of at least approximately seventy degrees Celsius. In another embodiment, the base belt segment is formed of polyester and heated to a temperature of approximately forty-eight degrees Celsius. In another embodiment, the base belt segment is formed of cotton and heated to a temperature of approximately twenty-four degrees Celsius. In another embodiment, the base belt segment is formed of polycarbonate and heated to a temperature of approximately thirty degrees Celsius. In another embodiment, the base belt segment is formed of polypropylene and heated to a temperature of approximately forty degrees Celsius. In one embodiment, heat is controlled manually. In another embodiment, heat is controlled automatically, taking ambient temperature and the type of belt material being used into account.

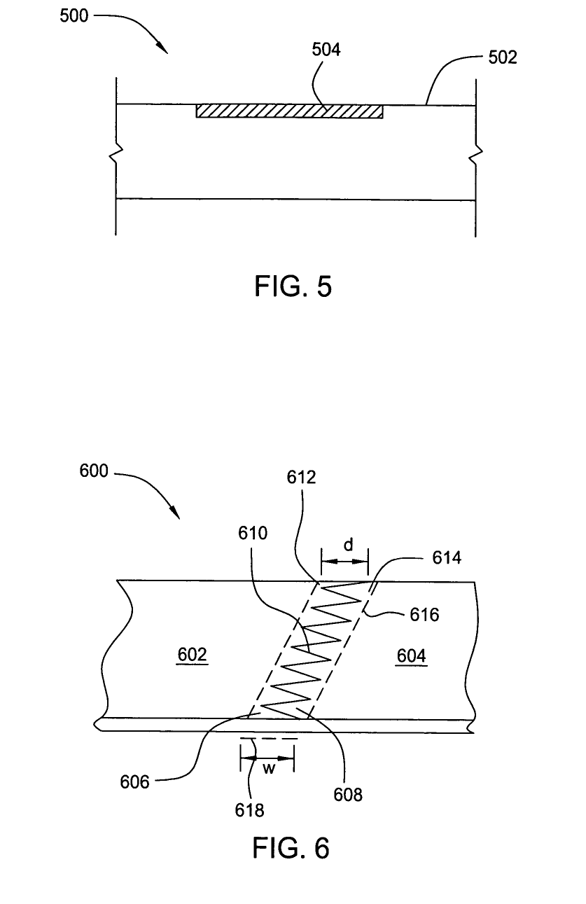

In step 306, the method 300 applies one or more inks that penetrate a surface layer of the belt to form an image therein. FIG. 5 is a side cross-segmental view illustrating one embodiment of a base belt segment 500. As illustrated, ink 504 is applied to the surface layer 502 of the base belt segment 500 in accordance with step 306, so that the ink 504 penetrates or embeds itself in the material of the base belt segment 500, forming a resultant image that is chemically bonded, in a substantially permanent manner, below the surface of the base belt segment 500. In one embodiment, the inks are solvent-based, and the concentration of the solvent varies with the type of belt material being treated. In one embodiment, the solvent used in the inks is at least one of methyl ethyl ketone and benzyl alcohol. In one embodiment, the inks are applied using stainless steel ink jet tips. Once the ink has penetrated the belt material, the method 300 terminates in step 308. In some embodiments, drying (e.g., using a drying fan) is used to permanently set the ink in the belt material.

A conveyor belt segment is therefore formed having an image that is embedded, in a substantially permanent manner, into the segment. Thus, because the image is not simply printed on to the top of the segment, it is substantially resistant to wear, scratching and cracking. As a further advantage, there is no need for additional coating material to seal or set the image, reducing production time and costs. Moreover, the method 400 may be performed using a modified ink jet printer and stainless steel ink jets tips so that up to approximately 1140 dots per inch (dpi) of ink can be applied at a rate of approximately 375 square feet per hour, producing images having photo-quality resolution.

FIG. 4 is a flow diagram of one embodiment of a method 400 for forming a conveyor belt, such as the conveyor belt 104 illustrated in FIG. 1, using a plurality of conveyor belt segments (e.g., as formed in accordance with the method 300 illustrated in FIG. 3). The method 400 is initialized in step 402 and proceeds to step 404, where the method cuts each conveyor belt segment (e.g., having an inked image already formed thereon) to a predefined size. In one embodiment, step 404 includes die cutting jagged or serrated fingers into each end of the conveyor belt segment (e.g., as illustrated in FIG. 2). The method 400 then proceeds to step 406 and joins the fingers of two conveyor belt segments so that the fingers are mutually engaged or interlocked. In step 408, the method 400 heats the conveyor belt segments so that the fingers fuse together, thereby attaching the two conveyor belt segments together. The temperature to which the conveyor belt segments are heated will depend on the belt material. For example, in one embodiment, the belt segments are formed of PVC and heated to a temperature of approximately 160-165 degrees Celsius. In another embodiment, polyurethane or Nitril rubber belt segments are heated to a temperature of approximately 180-185 degrees Celsius.

FIG. 6 is an isometric view illustrating one embodiment of first and second conveyor belt segments 602 and 604 that are joined together in accordance with the method 400 to form a single conveyor belt 600. As illustrated, the teeth 606 and 608 of the first and second respective conveyor belt segments 602 and 604 are engaged and “melted” together to form a joint 610. The joint 610 has a length, d, that extends from the base 612 of the teeth 606 to the base 614 of the teeth 608.

Referring back to FIG. 4, in one embodiment, the method 400 may proceed, after fusing the fingers together, to optional step 410 (illustrated in phantom), where the resultant joint is sealed or reinforced. In one embodiment, illustrated in FIG. 6, the joint 610 is reinforced by one or more layers of sealing material 616 and 618 (illustrated in phantom) that are placed on at least one planar face of the joint 610. In one embodiment, the sealing material layers 616 and 618 have a width, w, that is greater than the length, d, of the joint 610. In one embodiment, the sealing material layers 616 and 618 are formed of foil. The method 400 may be repeated any number of times to add additional conveyor belt segments until a conveyor belt having the desired length is produced.

Once cool, the “finger splice” joint 610 has a strength substantially equal to that of the conveyor belt segments 602 and 604 themselves and is substantially invisible. The joint 610 is therefore preferable to conventional conveyor belt joints, which typically comprise unaesthetic and unreliable metal fasteners. Moreover, the joints 610 can be undone using a portable die and portable heat press, so that new conveyor belt segments (e.g., having new images or advertisements formed thereon) can be fused to existing segments.

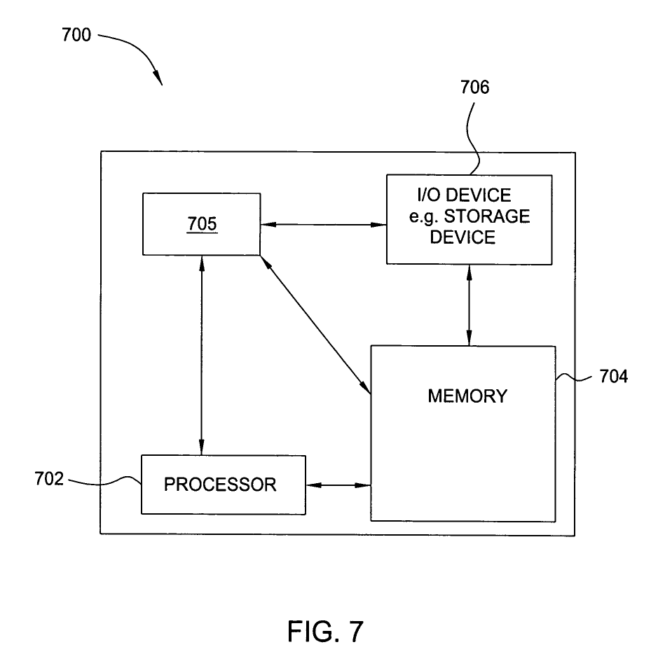

FIG. 7 is a high level block diagram of the present dynamic resource allocation system that is implemented using a general purpose computing device 700. In one embodiment, a general purpose computing device 700 comprises a processor 702, a memory 704, an image embedder or module 705 and various input/output (I/O) devices 706 such as a display, a keyboard, a mouse, a modem, and the like. In one embodiment, at least one I/O device is a storage device (e.g., a disk drive, an optical disk drive, a floppy disk drive). It should be understood that the image embedder 705 can be implemented as a physical device or subsystem that is coupled to a processor through a communication channel.

Alternatively, the image embedder 705 can be represented by one or more software applications (or even a combination of software and hardware, e.g., using Application Specific Integrated Circuits (ASIC)), where the software is loaded from a storage medium (e.g., I/O devices 706) and operated by the processor 702 in the memory 704 of the general purpose computing device 700. Thus, in one embodiment, the image embedder 705 for embedding inked images in a conveyor belt segment described herein with reference to the preceding Figures can be stored on a computer readable medium or carrier (e.g., RAM, magnetic or optical drive or diskette, and the like).

Thus, the present invention represents a significant advancement in the field of conveyor belt inking. A method and apparatus are provided that produce conveyor belt segments having images such as advertisements embedded into the belt material. Because the images are chemically bonded below the surfaces of the conveyor belt segments, the images are less prone to wear (such as scratching, fading and cracking) than existing printed-image belt segments. Moreover, the segments can be attached in a manner than is substantially invisible and at least as string as conventional metal fastener connections.

While the foregoing is directed to embodiments of the invention, other and further embodiments of the invention may be devised without departing from the basic scope thereof, and the scope thereof is determined by the claims that follow.

What is claimed is:

1. A method for forming a conveyor belt having one or more inked images formed therein, the method comprising the steps of:
providing at least one belt segment; and
applying at least one ink to said at least one belt segment to form an embedded image within a surface layer thereof.

2. The method of claim 1, further comprising the step of:
softening said at least one belt segment prior to applying said at least one ink.

3. The method of claim 2, where said at least one belt segment is softened by heating.

4. The method of claim 3, wherein said at least one belt segment is heated to a temperature of at least approximately seventy degrees Celsius.

5. The method of claim 3, wherein the heat is controlled manually.

6. The method of claim 3, wherein the heat is controlled automatically.

7. The method of claim 1, wherein said at least one ink is a solvent-based ink.

8. The method of claim 7, wherein a solvent used in said at least one ink is at least one of methyl ethyl ketone or benzyl alcohol.

9. The method of claim 1, wherein said method is performed by an ink jet printer.

10. The method of claim 9, wherein said applying step is performed using stainless steel ink jet tips.

11. The method of claim 1, further comprising the step of:
cutting said at least one belt segment to a predefined size, wherein said at least one belt segment has a substantially rectangular shape; and
forming a set of fingers in each of two opposing edges of said at least one belt segment.

12. The method of claim 11, further comprising the steps of:
engaging two sets of fingers so that said two sets of fingers interlock; and
fusing said two sets of fingers together to form a joint.

13. The method of claim 12, wherein said two sets of fingers are fused by heating.

14. The method of claim 12, further comprising the step of:
reinforcing said joint by sealing said joint between two or more layers of sealing material.

15. The method of claim 14, wherein said sealing material is foil.

16. A computer readable medium containing an executable program forming a conveyor belt having one or more inked images formed therein, where the program performs the steps of:
providing at least one belt segment; and
applying at least one ink to said at least one belt segment to form an embedded image within a surface layer thereof.

17. The computer readable medium of claim 16, further comprising the step of:
softening said at least one belt segment prior to applying said at least one ink.

18. The computer readable medium of claim 17, where said at least one belt segment is softened by heating.

19. The computer readable medium of claim 18, wherein said at least one belt segment is heated to a temperature of at least approximately seventy degrees Celsius.

20. The computer readable medium of claim 18, wherein the heat is controlled manually.

21. The computer readable medium of claim 18, wherein the heat is controlled automatically.

22. The computer readable medium of claim 16, wherein said at least one ink is a solvent-based ink.

23. The computer readable medium of claim 22, wherein a solvent used in said at least one ink is at least one of methyl ethyl ketone or benzyl alcohol.

24. The computer readable medium of claim 16, wherein said method is performed by an ink jet printer.

25. The computer readable medium of claim 24, wherein said applying step is performed using stainless steel ink jet tips.

26. A computer readable medium of claim 16, further comprising the step of:
cutting said at least one belt segment to a predefined size, wherein said at least one belt segment has a substantially rectangular shape; and
forming a set of fingers in each of two opposing edges of said at least one belt segment.

27. The computer readable medium of claim 26, further comprising the steps of:
engaging two sets of fingers so that said two sets of fingers interlock; and
fusing said two sets of fingers together to form a joint.

28. The computer readable medium of claim 27, wherein said two sets of fingers are fused by heating.

29. The method of claim 27, further comprising the step of:
reinforcing said joint by sealing said joint between two or more layers of sealing material.

30. The method of claim 29, wherein said sealing material is foil.

31. An apparatus for forming a conveyor belt segment having one or more inked images formed therein, comprising:
means for providing at least one belt segment; and
means for applying one or more inks to said at least one belt segment to form an embedded image in a surface layer thereof.

32. A conveyor belt segment for use in a conveyor belt, comprising:
a planar first surface defined by first, second, third and fourth edges, said first and second edges being substantially parallel and said third and fourth edges being substantially perpendicular to said first and second edges;
at least one inked image embedded within a surface layer of said planar first surface in a substantially permanent manner.

33. The conveyor belt member of claim 32, wherein said conveyor belt member is formed of a substantially flexible material.

34. The conveyor belt member of claim 33, wherein said conveyor belt member is formed of at least one of polyurethane, poly(vinyl) chloride or Nitrile rubber.

35. The conveyor belt member of claim 32, wherein said at least one inked image comprises at least one solvent-based ink chemically bonded to said surface layer of said planar first surface

36. A conveyor belt comprising:
one or more conveyor belt segments joined together to form said conveyor belt, where at least one of said conveyor belt segments comprises:
a planar first surface defined by first, second, third and fourth edges, said first and second edges being substantially parallel and said third and fourth edges being substantially perpendicular to said first and second edges; and
at least one inked image embedded within a surface layer of said planar first surface in a substantially permanent manner.
